(19) United States
(12) Patent Application Publication
(10) Pub. No.: US 2025/0029184 A1
(43) Pub. Date: Jan. 23, 2025

(54) ACCELERATED TRANSACTION SERVICE

(71) Applicant: American Express Travel Related Services Company, Inc., New York, NY (US)

(72) Inventors: Mohammed Hanif Badi, New York, NY (US); Nipun Goel, Atlanta, GA (US); Vipul Gupta, Gurgaon (IN); Pawan P. Kumar, New York, NY (US); Adwitiya Sarkar, Bengaluru Urban (IN); Bharathram Thothadri, New York, NY (US); Supriya Challa Thumpasery, Hoboken, NJ (US)

(21) Appl. No.: 18/222,604

(22) Filed: Jul. 17, 2023

(51) Int. Cl. G06Q 40/08; G06Q 20/02; G06Q 20/38; G06Q 20/40; G06Q 20/42

(52) U.S. Cl. CPC G06Q 40/08; G06Q 20/02; G06Q 20/389; G06Q 20/405; G06Q 20/42

(57) ABSTRACT

Disclosed are various embodiments for accelerating transactions and managing cashflow by predicting and crediting payment amounts for requests for payments that are satisfied by third party providers (e.g., insurance providers, claim payment providers, etc.). A user who is a registered participant in an accelerated transaction program can submit a claim to a claim payment provider requesting payment or reimbursement of funds associated with an event. While waiting for the claim payment provider to process the claim, trained models can be used to analyze the claim data, user data, claim payment provider data, historical data, and/or other information to (1) predict whether the claim will be approved by the claim payment provider and (2) estimate an amount that will be provided to the medical provider by claim payment provider. The user can be credited for the predicted amount while waiting for the claim to be processed.

### BACKGROUND

Insurance providers or other type of payment providers can enter into agreements with individuals and/or other types of entities to reimburse and/or cover funds associated with services performed, losses, damages, and/or other events covered by the agreements. In various examples, a claim associated with an event can be submitted to the insurance provider or other type of payment provider requesting receipt and/or reimbursement of funds associated with the event and the provider can initiate a transaction to provide the funds based at least in part of the terms of the agreement. For example, a medical provider can perform a medical service to a patient and submit a claim to an insurance provider associated with the patient requesting funds for the medical service that was performed. The insurance provider can process the claim and, when approved, provide the medical provider with a payment of funds associated with the medical service and the terms of the agreement.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing depicting one of several embodiments of the present disclosure.

FIG. 2 is a drawing of a network environment according to various embodiments of the present disclosure.

FIGS. 3A-5 are sequence diagrams depicting the interactions between the various components of the network environment of FIG. 2 according to various embodiments of the present disclosure.

FIGS. 6A and 6B are flowcharts illustrating examples of functionality implemented as portions of an application executed in a computing environment in the network environment of FIG. 2 according to various embodiments of the present disclosure.

### DETAILED DESCRIPTION

Disclosed are various approaches for accelerating transactions and managing cashflow by predicting and crediting payment amounts for requests for payments that are satisfied by third party providers (e.g., insurance providers, claim payment providers, etc.). For example, a user can submit a claim or request a payment of funds for services performed, losses, damages, and/or other type of payment events. The claim can be submitted to an insurance provider or other claim payment provider who processes the request or claim and approves or denies the request based at least in part on the event and terms of an agreement. Typically, a user can suffer a gap in cashflow while waiting for the third-party provider to process a submitted claim or request. However, in accordance with various embodiments, registered participants in an accelerated transaction program can receive a credit payment associated with the request for payment to help compensate for the gap in cashflow. By using computing devices and trained models to automatically analyze claim requests and predict expected payment amounts, the speed and accuracy associated with accelerating payment requests to minimize gaps in cashflow can be greatly increased.

According to various examples, when a registered participant in an accelerated transaction program submits a claim and/or a request for payment of funds associated with an event, attributes can be obtained from the claim and/or request, historical user data, historical claim data, third-party provider data, and/or other data. These attributes can be applied to models that are trained to predict a probability that the request will be approved and predict a payment amount for satisfying the request. While waiting for the insurance provider or other claim payment provider to approve and provide the requested funds, registered participants in the accelerated transaction program can be eligible to receive a credit payment that is based at least in part on the predicted payment amount. Once the claim payment provider approves and satisfies the request (e.g., provides payment to the requestor), denies the request, and/or a predefined period of time has elapsed, the accelerated payment of funds can be debited from the requestor's transaction account.

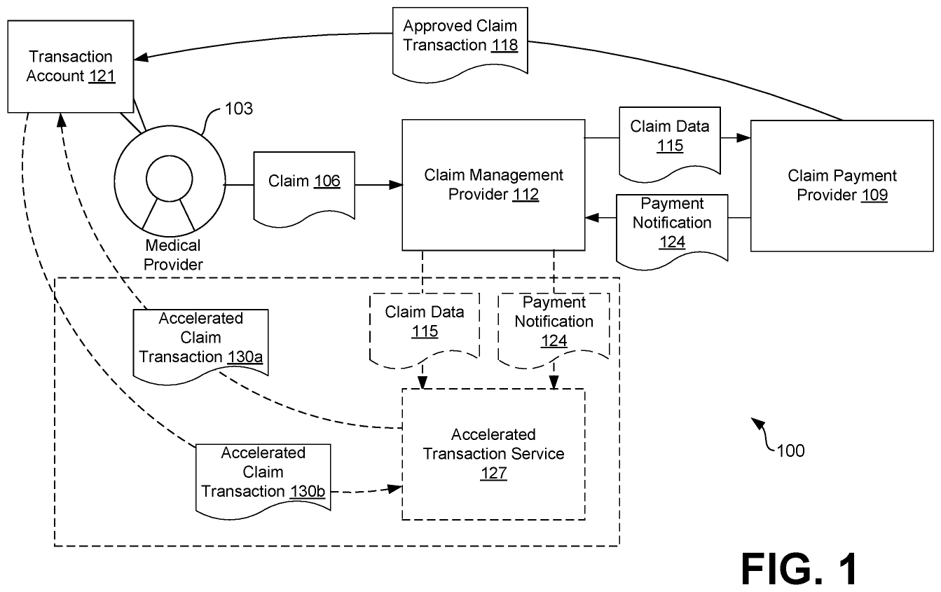

Turning now to FIG. 1, shown is an example scenario 100 illustrating how cashflow for a medical provider 103 can be accelerated when the medical provider 103 is a registered participant in an accelerated transaction program. In particular, the example scenario relates to a medical provider 103 submitting a claim 106 to a claim payment provider 109 (e.g., insurance provider) requesting payment of fees associated with a service performed by the medical provider 103. In the example of FIG. 1, the typical claim submission process is illustrated by solid lines and the addition of the accelerated transaction program process is illustrated by dashed lines.

To begin, a medical provider 103 may perform a service for a patient having an agreement with a claim payment provider 109 that allows the claim payment provider 109 to provide payment for the services to the medical provider 103 on behalf of the patient. In order to receive payment for the performed service, the medical provider 103 submits a claim 106 that includes details associated with the service performed. In various examples, the claim 106 includes a request for payment or reimbursement of funds that the medical provider 103 believes is owed to them based at least in part on the services performed. In some examples, the claim 103 can include a form (e.g., 837 form) that is an electronic file that contains patient claim information (e.g., patient identifier, diagnosis code, service code, claim payment provider information, length of stay, service type, etc.).

In some examples, the claim 106 is submitted directly to the claim payment provider 109. In other examples, as shown in FIG. 1, the claim 106 can be submitted by the medical provider 103 to a claim management provider 112 (e.g., Revenue Cycle Management (RCM) provider). A claim management provider 112 can function as an intermediary between the medical provider 103 and the claim payment provider 109 to facilitate in the financial management process associated with services provided by the medical provider 103 and receipt of payment for those services.

Typically, upon receipt of the claim 106 from the medical provider 103, the claim management provider 112 can generate claim data 115 by reformatting the information included in the claim 106 into a format that is accepted by the claim payment provider 109. Upon generating the claim data 115, the claim management provider 112 can submit the claim data 115 to the claim payment provider 109 who in turn processes the claim 106 and determines whether to approve or deny the claim. If approved, the claim payment provider 109 can initiate an approved claim transaction 118 with the medical provider 103 to provide payment of the approved funds to the transaction account 121 associated with the medical provider 103. The claim payment provider 109 can also generate and send a payment notification 124 to the claim management provider 112 indicating that the approved claim transaction 118 associated with the submitted claim 106 has been processed and approved.

Due to the time delay that may occur from submission of the claim 106 by the medical provider 103 and initiating the approved claim transaction 118 by the claim payment provider 109, the medical provider 103 can become a registered participant in an accelerated transaction program that allows the medical provider 103 to better manage cashflow by receiving accelerated payments (e.g., credits) that are based at least in part on a predicted payment amount. This is illustrated by the dashed lines of FIG. 1.

In the example of FIG. 1, upon receiving the claim 106 from the medical provider 103, the claim management provider 112 can determine that the medical provider 103 is a registered participant in the accelerated transaction program and that the medical provider 103 has provided consent for the claim management provider 112 to provide claim data 115 associated with the claim 106 to the accelerated transaction service 127. As such, the claim management provider 112 can provide the claim data 115 to the accelerated transaction service 127 in addition to providing the claim data 115 to the claim payment provider 109. The accelerated transaction service 127 can execute trained models to analyze the claim data 115, user data, claim payment provider data, historical data, and/or other information to (1) predict whether the claim 103 will be approved by the claim payment provider 109 and (2) estimate an amount that will be provided to the medical provider 103 by claim payment provider 109.

In various examples, the accelerated transaction service 127 can identify attributes associated with the claim data 115, user data, claim payment provider data, historical data, and/or other type of data associated with the event. Using the example of FIG. 1 with respect to a medical provider 103 submitting a claim 103 based on services performed on a patient, the attributes can include claim payment provider identifier, a sum of historical payments for claims of the same patient, a number of no payment claims associated with the same patient, a service code, a diagnosis type, a number of claims associated with the patient, a type of claim payment provider, an average number of noncovered and/or denied amounts for the type of service provided, historical data associated with past payments of claims between the medical provider 103 and the claim payment provider 109 for the service performed, a length of stay or time for services to be performed, a number of diagnosis, and/or other information.

In various examples, upon predicting that the claim 103 will be approved by the claim payment provider 109 and estimating the amount that will be provided to the medical provider 103, the accelerated transaction service 127 can initiate an accelerated claim transaction 130a that provides a credit to the transaction account 121 in an amount that is based at least in part on the estimated amount. For example, the accelerated claim transaction 130a can correspond to a credit in the amount of the estimated amount less a service fee associated with participation in the accelerate transaction program. In other examples, the estimated amount may exceed a credit limit provided by the accelerated transaction program to the medical provider and the accelerated claim transaction 130a can correspond to a credit in the amount of the difference between the credit limit and the estimated amount less the service fee. Accordingly, the medical provider 103 can be provided with an accelerated payment of funds to cover the costs associated with the service provided while waiting for the claim payment provider 109 to process and approve the submitted claim 106.

In various examples, once the claim management provider 112 receives the payment notification 124 from the claim payment provider 109, the claim management provider 112 can send the payment notification 124 to the accelerated transaction service 127. As such, the accelerated transaction service 127 can initiate an accelerated claim transaction 130b that debits, from the transaction account 121, the amount that was credited to the transaction account 121 via the accelerated claim transaction 130a. In some examples, if the accelerated transaction service 127 fails to receive the payment notification 124 after a predefined period of time (e.g., sixty days) or after a given number cycles (e.g., 3 cycles) following date of payment, the accelerated transaction service 127 can initiate the accelerated claim transaction 130b to debit, from the transaction account 121, the amount that was credited to the transaction account 121 via the accelerated claim transaction 130a.

In some examples, the accelerated transaction service 127 can initiate the accelerated claim transaction 130b that debits the amount from the transaction account 121 in response to receiving the payment notification 124 and/or determining that a payment notification 124 has failed to be received during an allotted time period. In other examples, the accelerated transaction service 127 can initiate the accelerated claim transaction 130b that debits an aggregated amount from the transaction account 121 in accordance to a given date (e.g., due date) or interval period (e.g., weekly, monthly, etc.). For example, an accelerated claim transaction 130b that debits funds from the transaction account 121 can be initiated in accordance to an interval period (e.g., monthly) and the amount debited can correspond to the aggregated amount associated with one or more claims where payment notifications 124 were received during the interval period plus any outstanding amounts that have not been satisfied by the third-party claim payment provider 109 after a predefined period of time and/or number of cycles.

It should be noted that while the example described in FIG. 1 references a medical provider 103 requesting payment of services from a third-party claim payment provider 109 (e.g., insurance provider) in the form of a claim 106, the accelerated transaction management program and corresponding prediction models executed by the accelerated transaction service 127 can be applied to any type of situation where an entity is requesting and/or expecting a payment from a third-party in response to an event (e.g., service performed, loss of property and/or life, damage of property and/or life, reimbursable expense, etc.) and where the third-party does not immediately provide a payment to the requestor, thereby causing a gap in cashflow for the requesting party. For example, an invoice associated with a service performed by a service provider can correspond to a claim 106 such that the service provider can submit the invoice to the accelerated transaction service 127 for an accelerated payment to account for a gap in cashflow for the requesting party (e.g., service provider). In another example, if an entity suffers from damage from property, the claim 106 can correspond to an amount associated with the damage of property that the entity may be due. The claim 106 can include information about the property and the damage to the property and the accelerated transaction service 127 can estimate an amount to be paid to cover the damage and/or whether payment will be recovered.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

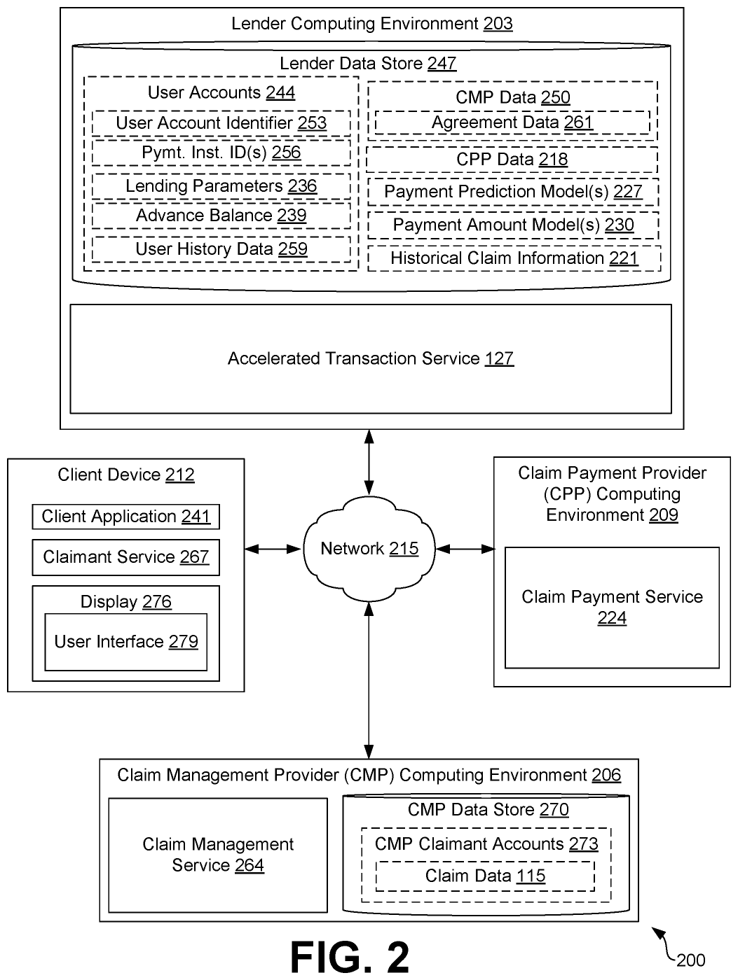

With reference to FIG. 2, shown is a network environment 200 according to various embodiments. The network environment 200 can include a lender computing environment 203, a claim management provider (CMP) computing environment 206, a claim payment provider (CPP) computing environment 209, and a client device 212, which can be in data communication with each other via a network 215.

The network 215 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 215 can also include a combination of two or more networks 215. Examples of networks 215 can include the Internet, intranets, extranets, virtual private networks (VPNs), and similar networks.

The lender computing environment 203, the CMP computing environment 206 and/or the CPP computing environment 209 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the lender computing environment 203, the CMP computing environment 206 and/or the CPP computing environment 209 can employ a plurality of computing devices that can be arranged in one or more server banks or computer banks or other arrangements. Such computing devices can be located in a single installation or can be distributed among many different geographical locations. For example, the lender computing environment 203, the CMP computing environment 206 and/or the CPP computing environment 209 can include a plurality of computing devices that together can include a hosted computing resource, a grid computing resource, or any other distributed computing arrangement. In some cases, the lender computing environment 203, the CMP computing environment 206 and/or the CPP computing environment 209 can correspond to an elastic computing resource where the allotted capacity of processing, network, storage, or other computing-related resources can vary over time.

Various applications or other functionality can be executed in the lender computing environment 203. The components executed on the lender computing environment 203 include an accelerated transaction service 127, and other applications, services, processes, systems, engines, or functionality not discussed in detail herein.

The accelerated transaction service 127 can be executed to analyze claim data 115 associated with a claim 103 (FIG. 1) submitted by a registered participant in an accelerated transaction program. In various examples, the accelerated transaction service 127 can execute trained models to analyze the claim data 115 along with user account data, claim payment provider data 218, historical claim data 221, and/or other data to (1) predict whether the claim 103 will be approved by the claim payment provider 109 (FIG. 1) associated with the CPP computing environment 209 and (2) estimate an amount that will be provided to the registered participant by claim payment provider 109 and/or claim payment service 224.

In various examples, the accelerated transaction service 127 can determine attributes associated with the claim data 115, user data, claim payment provider data, historical data, and/or other type of data associated with the event. Using the example of FIG. 1 with respect to a medical provider 103 submitting a claim 103 based on services performed on a patient, the attributes may include claim payment provider identifier, a sum of historical payments for claims of the same patient, a number of no payment claims associated with the same patient, a service code, a diagnosis type, a number of claims associated with the patient, a type of claim payment provider, an average number of noncovered and/or denied amounts for the type of service provided, historical data associated with past payments of claims between the medical provider 103 and the claim payment provider 109 for the service performed, a length of stay or time for services to be performed, a number of diagnosis, and/or other information.

In various examples, the accelerated transaction service 127 can execute a payment prediction model 227 and apply a first set of attributes from the determined attributes as inputs to the payment prediction model 227. The payment prediction model 227 can be trained to output a payment prediction score which can be used to predict whether the claim payment provider 109 will approve the claim 106 and provide a payment to the registered participant for the services and/or other events associated with the claim 106. For example, if the payment prediction score meets or exceeds a predefined threshold value, the accelerated transaction service 127 can predict that the claim 106 will be approved and a payment will be made by the claim payment provider 109. Otherwise, the accelerated transaction service 127 may generate a notification to be presented on a dashboard or user interface 279 rendered on a client device 212 associated with the registered participant indicating that the claim 106 is predicted to be rejected or otherwise unsatisfied.

The accelerated transaction service 127 can further be executed to apply a second set of attributes to a payment amount model 230 which is trained to provide an estimated amount for what is predicted to be provided to the registered participant by the claim payment provider 109 in view of the submitted claim 106. In some examples, the first set of attributes are the same as the second set of attributes. In other examples, the first set of attributes can differ from the second set of attributes. As such, the attributes that are used to predict payment can differ from the attributes used to estimate a payment amount.

In various examples, the accelerated transaction service 127 can determine whether the registered participant is in good standing with the accelerated transaction program and/or determine whether the estimated amount is within the credit limit assigned to the registered participant. For example, the accelerated transaction service 127 can review the user account data including the user history data 259 to determine whether the registered participant satisfies the terms set forth in an agreement between the registered participant and an entity associated with the accelerated transaction program.

In addition, the accelerated transaction service 127 can determine the current credit limit associated with the registered participant to determine whether the estimated amount is within the current credit limit or whether the estimated amount exceeds the current credit limit. In some examples, the current credit limit can be determined by calculating the difference between the assigned credit limit that can be included in the lending parameters 236 of the user account data with the advance balance 239 associated with the registered participant. For example, a registered participant may have a credit limit of $10,000 and may have already received credits of up to $9500 (e.g., account balance 239) for previously submitted claims that are still waiting to be approved and/or processed by the claim payment provider 109. The advance balance 239 can correspond to the amount of received credits that have already been provided to the registered participant. As such, if the estimated amount exceeds $500, for this example, the accelerated transaction service 127 can determine that only $500 or less of the total estimated amount will be credited to the transaction account 121 of the registered participant.

In various examples, upon determining the estimated amount and/or the available amount to provide to the registered participant, the accelerated transaction service 127 can initiate an accelerated claim transaction 130a (FIG. 1) that provides a credit that is based at least in part on the estimated amount to the transaction account 121 associated with the registered participant. In some examples, the credited amount corresponds to the estimated amount or available amount. In other examples, the credited amount corresponds to the estimated amount or available amount less a service fee for participation in the accelerated transaction program. Upon determining that the registered participant has received a payment from the claim payment provider 109 and/or a predefined period of time has elapsed, the accelerated transaction service 127 can initiate an accelerated claim transaction 130b that debits funds from the transaction account 121 that correspond to the amount credited in the accelerated claim transaction 130a.

In various examples, the accelerated transaction service 127 can be executed to onboard a user to participate in the accelerated transaction program. For example, a user interacting with a client application 241 on a client device 212 can send a request to the accelerated transaction service 127 requesting to become a registered participant with the accelerated transaction program. The user can further submit an application to register. In some examples, the application is included in the request. In other examples, the application is provided separately from the request.

In cases where a claim management provider 112 (FIG. 1) is involved, the accelerated transaction service 127 can request consent from the user to allow the claim management provider 112 to send claim data 115 associated with the user to the accelerated transaction service 127. In some examples, the consent is included in the request. In other examples, the consent is provided separately from the request.

Once the user provides consent and submits the application, the accelerated transaction service 127 can obtain claim data 115 from the claim management provider 112. The obtained claim data 115 can correspond to a plurality of claims submitted by the user to one or more claim payment providers 109 via the claim management provider 112. The accelerated transaction service 127 can analyze the data and approve the user to participate in the accelerated transaction program based at least in part on the analysis. In various examples, the accelerated transaction service 127 and the user can finalize the agreement and the accelerated transaction service 127 can generate a user account 244 for the user to register with the accelerated transaction program. In various examples, the accelerated transaction service 127 can determine a credit limit based at least in part on user data associated with the user, application data, the claim data 115, and/or other type of information. The terms of the agreement can be included in the lending parameters 236 associated with the user account 244.

Also, various data is stored in a lender data store 247 that is accessible to the lender computing environment 203. The lender data store 247 can be representative of a plurality of lender data stores 247, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the lender data store 247 is associated with the operation of the various applications or functional entities described below. This data can include one or more user accounts 244, CMP data 250, CPP data 218, payment prediction model(s) 227, payment amount model(s) 230, historical claim data 221, and potentially other data.

Each user account 244 can represent a user or entity that has registered to participate in an accelerated transaction program that provides advances of funds to the user or entity based at least in part on a prediction that a claim 106 or request for a payment of the funds will be approved and paid by a claim payment provider 109. Accordingly, information about the user can be stored in his or her user account 244, such as a user account identifier 253, one or more payment instrument identifiers 256, lending parameters 236, advance balance 239, and/or user history data 259.

The user account identifier 253 can represent an identifier that uniquely identifies a user account 244 with respect to another user account 244. Examples of user account identifiers 244 can include usernames, globally unique identifiers (GUIDs), universally unique identifiers (UUIDs), incremental counters or values, etc. Each payment instrument identifier 256 can represent an identifier that uniquely identifies a payment instrument (e.g., a credit card, debit card, charge card, bank account, payment account, etc.) with respect to another payment instrument. Examples of payment instrument identifiers 256 include credit, debit, or charge card numbers; bank account numbers; or tokens that obfuscate or provide an alias for debit, credit, charge, or bank account numbers. For example, a payment instrument identifier 256 can be used to identify a transaction account 121 (FIG. 1) of the registered participant that the accelerated transaction service 127 can use to credit and/or debit funds in an accelerated claim transaction 130.

The lending parameters 236 can include terms agreed upon between the user and a lending entity associated with the accelerated transaction service 127. For example, the lending parameters 236 can include a credit limit, a time period associated with the credit, a service fee amount, and/or other information. The advance balance 239 can correspond the amount of received credits that have already been provided to the registered participant, but have not yet been debited by the accelerated transaction service 127 in view of a payment by the claim payment provider 109 and/or lapse of time from credit payment.

The user history data 259 can include historical data associated with the user. In various examples, the user history data 259 can include historical claim data 115, credit history data, claim payment data, user event data, outcomes of prior claims, and/or other type of data that can be used to predict future payments of claims and/or amounts of future payments.

The CMP data 250 includes data associated with one or more claim management providers 112. A claim management provider 112 can function as an intermediary between the registered participant submitting a claim 106 and the claim payment provider 109 to facilitate in the financial management process associated with services provided by or events associated with the registered participant and receipt of payment for those services and/or events. For example, a claim management provider 112 can include a revenue cycle management (RCM) provider. An RCM provider can comprise an entity who identifies, manages, and collects patient service revenue and can act as an intermediary between a medical provider 103 and a claim payment provider 109. The CMP data 250 can include a claim management provider identifier, contact information associated with contacts for a claim management provider 112, consent data provided by registered participants interacting with the claim management provider 112, agreement data 261, and/or other type of information associated with a claim management provider 112. Agreement data 261 can include terms associated with an agreement entered between a claim management provider 112 and a lending entity associated with the lender computing environment 203.

CPP data 218 represents data associated with one or more claim payment providers 109. For example, the CPP data 218 can include a claim payment provider identifier, claim payment provider contact information, a type of claim payment provider, historical claim payment data associated with submitted claims to the claim payment provider, and/or any other information associated with the claim payment provider 109. In various examples, a claim payment provider 109 can correspond to an insurance provider or other type of claim payment provider.

A payment prediction model 227 includes a model that is trained to a predict whether a claim payment provider 109 will approve and make a payment for claim 106 submitted by a user who is a registered participant in the accelerated payment program. For example, the payment prediction model 227 can be trained to output a payment prediction score which can be used to predict whether the claim payment provider 109 will approve the claim 106 and provide a payment to the registered participant for the services and/or other events associated with the claim 106. In various examples, there can be multiple payment prediction models 227 that can each represent a different type of claim 106 being submitted. For example, one payment prediction model 227 can be used for medical providers 103 submitting medical claims 106 for medical services provided while another payment prediction model 227 can be used for claims 106 requesting payments for lost or damaged goods. In particular, the types of attributes associated with the different types of claims 106 will differ thereby causing the trained models 227 to differ.

The payment prediction model 227 can include, for example, a decision tree classifier, a gradient boost classifier, a Gaussian naïve Bayes classifier, a reinforcement learning algorithm, a logistic regression classifier, a random forest classifier, a decision tree classifier, a multi-layer perceptron classifier, a recurrent neural network, a neural network, a label-specific attention network, an ensemble model, and/or any other type of trained model as can be appreciated.

A payment amount model 230 includes a model that is trained to a predict an estimated amount that a claim payment provider 109 will provide to a claim submitting party if the claim 106 is approved for payment. For example, a payment amount model 230 which is trained to output a value corresponding to an estimated amount for what is predicted to be provided to the registered participant by the claim payment provider 109 in view of the submitted claim 106. In various examples, there can be multiple payment amount models 230 that can each represent a different type of claim 106 being submitted. For example, one payment amount model 230 can be used for medical providers 103 submitting medical claims 106 for medical services provided while another payment amount model 230 can be used for claims 106 requesting payments for lost or damaged goods. In particular, the types of attributes associated with the different types of claims 106 will differ thereby causing the trained models 230 to differ.

The payment amount model 230 can include, for example, a decision tree classifier, a gradient boost classifier, a Gaussian naïve Bayes classifier, a reinforcement learning algorithm, a logistic regression classifier, a random forest classifier, a decision tree classifier, a multi-layer perceptron classifier, a recurrent neural network, a neural network, a label-specific attention network, an ensemble model, and/or any other type of trained model as can be appreciated.

Historical claim information 221 represents information corresponding to multiple claims 106 submitted by users and/or registered participants. In various examples, the historical claim information 221 can include, for example, a claim event type, a user data (e.g., user name, user identifier, etc.), diagnosis data, service code data, CPP data 218, a seasonality, an event length, and/or other information associated with a claim 106. In various examples, the historical claim information 221 can be updated to include confirmation as to whether a claim payment provider 109 approved a given claim 106 and the associated amount that was paid by the claim payment provider 109. In various examples, this information can be used to update and/or retrain the payment prediction model(s) 227 and/or the payment amount model(s) 230.

Various applications or other functionality can be executed in the CMP computing environment 206. In various examples, the CMP computing environment 206 can be associated with a claim management provider 112. A claim management provider 112 can function as an intermediary between the registered participant submitting a claim 106 and the claim payment provider 109 to facilitate in the financial management process associated with services provided by or events associated with the registered participant and receipt of payment for those services and/or events. For example, a claim management provider 112 can include a revenue cycle management (RCM) provider. An RCM provider can comprise an entity who identifies, manages, and collects patient service revenue and can act as an intermediary between a medical provider 103 and a claim payment provider 109. The components executed on the CMP computing environment 206 include a claim management service 264, and other applications, services, processes, systems, engines, or functionality not discussed in detail herein.

The claim management service 264 can be executed to receive claims 106 from a claimant service 267 executed on a client device 106 and transmit claim data 115 associated with the claims 106 to a claim payment service 224 of a CPP computing environment 209 and/or the accelerated transaction service 127. In particular, the claim management service 264 acts as an intermediary between the registered participant submitting a claim 106 and the claim payment provider 109 to facilitate in the financial management process associated with services provided by or events associated with the registered participant and receipt of payment for those services and/or events.

In addition, the claim management service 264 can interact with the accelerated transaction service 127 to provide claim data 115 submitted by registered participants to the accelerated transaction service 127 when the registered participant has provided consent to allow claim management service 264 to provide corresponding claim data 115 to the accelerated transaction service 127. In various examples, the claim management service 264 can be executed to received payment notifications 124 from the claim payment provider 124 and forward the payment notifications 124 to the accelerated transaction service 127, when applicable.

Also, various data is stored in a CMP data store 270 that is accessible to the CPP computing environment 206. The CMP data store 270 can be representative of a plurality of data stores 270, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the CMP data store 270 is associated with the operation of the various applications or functional entities described below. This data can include CMP claimant accounts 273, and potentially other data.

Each CMP claimant accounts 273 can represent a user or entity that has submitted a claim 106 or request requesting payment for services performed, loss, damages, and/or other type of claim event that the user expect payment for from a claim payment provider 109. For example, a CMP claimant account 273 can include a claimant identifier, claimant contact information, claim data 115 associated with one or more claims 106 submitted by the claimant, consent information, CPP data 218, and/or other type of information. The claim data 115 includes information related to a specific claim. The claim data 115 can include, for example, a claimant identifier, an event code (e.g., service code, loss goods code, etc.), a diagnosis code, claim payment provider information, event length, event type, and/or other type of information that can be used to describe a given claim 106.

Various applications or other functionality can be executed in the CPP computing environment 209. The CPP computing environment 209 can be associated with a claim payment provider 109, such as, for example, an insurance provider. The components executed on the CPP computing environment 209 include a claim payment service 224, and other applications, services, processes, systems, engines, or functionality not discussed in detail herein.

The claim payment service 224 can be executed to receive claim data 115 from the claim management service 264 executed in a CMP computing environment 206, a claimant service 267 executed on a client device 212, and/or other type of service that can provide claim data 115 that is associated with a claim 106. The claim payment service 224 can analyze the claim data 115 and determine whether to approve and/or deny the associated claim 106 based at least in part on agreement terms between the user and the claim payment provider 109. In some examples, manual review of the claim 106 is required prior to approval and/or denial of a claim. The claim payment service 224 can be executed to generate and send payment notifications 124 to the claim management service 264 and/or claimant service 267 to indicate an approved claim transaction 118 (FIG. 1) reflecting a payment corresponding to the approval of the claim 106.

The client device 212 is representative of a plurality of client devices that can be coupled to the network 215. The client device 212 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 212 can include one or more displays 276, such as liquid crystal displays (LCDs), gas plasma-based flat panel displays, organic light emitting diode (OLED) displays, electrophoretic ink (“E-ink”) displays, projectors, or other types of display devices. In some instances, the display 276 can be a component of the client device 212 or can be connected to the client device 212 through a wired or wireless connection.

The client device 212 can be configured to execute various applications such as a client application 241, a claimant service 267, and/or other applications. The client application 241 can be executed in a client device 212 to access network content served up by the lender computing environment 203, CMP computing environment 206, CPP computing environment 209, or other servers, thereby rendering a user interface 279 on the display 276. To this end, the client application 241 can include a browser, a dedicated application, or other executable, and the user interface 279 can include a network page, an application screen, or other user mechanism for obtaining user input. The client device 212 can be configured to execute applications beyond the client application 241 such as email applications, social networking applications, word processors, spreadsheets, or other applications. The claimant service 267 can be executed in a client device 212 to facilitate submission of a claim 106 in view of an event. In some examples, the claimant service 267 can render one or more user interfaces 279 and intake claims 106, claim information, and/or requests for a payment in view of an event (e.g., service performance, loss or damage of goods, etc.) In some examples, the claimant service 267 can include a client application 241. In other examples, the claimant service 267 includes a standalone application that is separate from a client application 241.

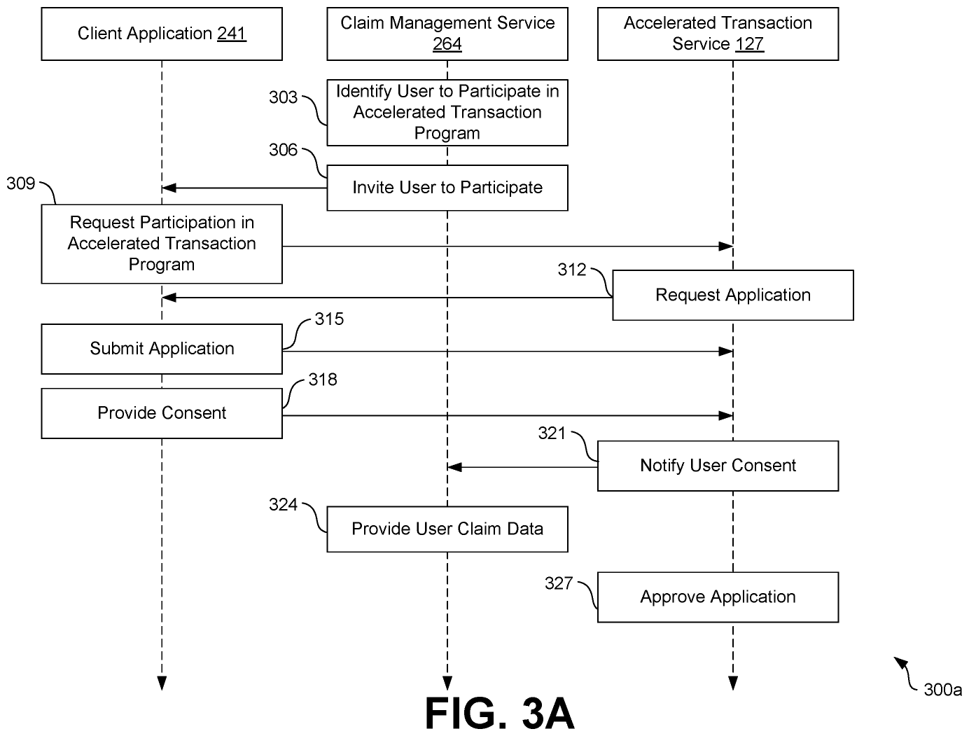

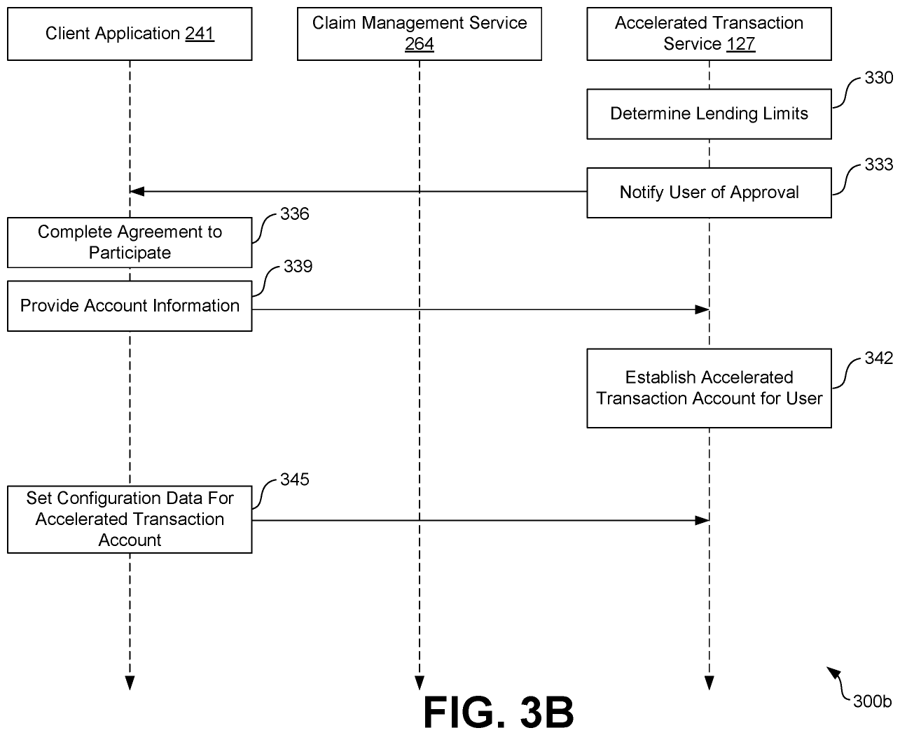

Next, a general description of the operation of the various components of the network environment 200 is provided with respect to FIGS. 3A-6B. To begin, FIGS. 3A-3B illustrate a sequence diagram 300 (e.g., 300a, 300b) that provides one example of the interactions between the client application 241, the claim management service 264, and the accelerated transaction service 127. The sequence diagram of FIGS. 3A-3B provides merely an example of the many different types of functional arrangements that can be employed by the client application 241, the claim management service 264, and/or the accelerated transaction service 127. As an alternative, the sequence diagram of FIGS. 3A-3B can be viewed as depicting an example of elements of a method implemented within the network environment 200. FIGS. 3A-3B provides an example of how a user can be onboarded as a registered participant with the accelerated transaction program according to various embodiments.

Beginning with block 303, the claim management service 264 identifies a user to participate in an accelerated transaction program. In various examples, the claim management service 264 acts as an intermediary between the user submitting a claim 106 and the claim payment provider 109 to facilitate in the financial management process associated with services provided by or events associated with the user and receipt of payment for those services and/or events. In various examples, the claim management provider 112 can enter into an agreement with the lending entity associated with the accelerated transaction service 127. In some examples, the agreement can include terms defining attributes that are preferred for users participating in the accelerated transaction program. In various examples, a user may have a CMP claimant account 273 with a claim management provider 112. The claim management service 264 can analyze the CMP claimant account 273 to identify attributes associated with the user that can be compared with the attributes used to identify the user for participation in the accelerated transaction program. For example, the CMP claimant account 273 may include information related to the number of claims the user submits, the turnaround time between claim submission and payment by the claim payment provider 109, an issuer entity associated with a transaction account 121 of the user, and/or other information.

In some examples, the claim management service 264 identities the user based at least in part on a recommendation provided by the accelerated transaction service 127. For example, the user may have payment accounts (e.g., bank accounts, credit accounts, debit accounts, etc.) with the lending entity associated with the lender computing environment 203. As such, the accelerated transaction service 127 can have access to user account data associated with the payment accounts and the accelerated transaction service 127 can identify a user from an analysis of the attributes associated with the user account data. Upon identifying a user, the accelerated transaction service 127 can send a recommendation to the claim management service 264 recommending the user to participate in the accelerated transaction program.

At block 306, the claim management service 264 invites the user to participate in the accelerated transaction program. For example, the claim management service 264 can generate an invitation and/or other type of notification that includes details about the accelerated transaction program. The claim management service 264 can transmit the invitation to a client device 212 associated with the user. In various examples, the invitation can include an email, an SMS message, a user interface, etc. In some examples, the invitation can include a link that, upon selection, redirects the user to a user interface 279 associated with the accelerated transaction service 127. It should be noted that although FIG. 3 illustrates the user being invited to participate in the accelerated transaction program, in some embodiments, the accelerated transaction service 127 can generate the invitation and invite the user to participate in the accelerated transaction program.

At block 309, the client application 241 requests participation in the accelerated transaction program. For example, a user can select a link included in the invitation received from the claim management service 264. Upon selection of the link, the client application 241 can be redirected to a registration page associated with the accelerated transaction service 127. In other examples, the user can interact with the client application 241 to request access to a registration page associated with the accelerated transaction service 127. The request to access the registration page can correspond to a request to participate in the accelerated transaction program. In some examples, the request to participate in the accelerated transaction program can be in response to a selection of a selectable component included on a user interface 279 associated with the accelerated transaction service 127.

At block 312, the accelerated transaction service 127 can request an application from the user by sending a request for the application to the client application 241. In various examples, the request for the application can include a request to complete an application form by providing information about the user. The information can include contact information, claim payment provider data 218, payment instrument identifiers 256, user financial information, and/or other type of information that may be required by the accelerated transaction service 127 to determine whether the user is eligible to participate in the accelerated transaction program.

At block 318, the client application 241 provides consent to the accelerated transaction service 127. The consent can correspond to an approval by the user to allow the claim management service 264 to provide claim data 115 to the accelerated transaction service 127. In some examples, the consent is included in the application. In some examples, the consent is included in the request to participate in the accelerated transaction program. In other examples, the consent is provided separately from the submission of the application and/or request to participate. In various examples, the consent is specific to one claim management provider 112. In other examples, the consent includes a blanket consent that covers multiple claim management providers 112.

At block 321, the accelerated transaction service 127 notifies the claim management service 264 of the consent provided by user through the client application 241. For example, the accelerated transaction service 127 can generate a notification and send the notification to the claim management service 264 over the network 215.

At block 324, the claim management service 264 can provide historical claim information 221 associated with the user to the accelerated transaction service 127. The claim information 221 represents information corresponding to claims 106 submitted by the user and includes claim data 115 generated by the claim management service 264. In various examples, the historical claim information 221 can include, for example, a claim event type, a user data (e.g., user name, user identifier, etc.), diagnosis data, service code data, CPP data 218, a seasonality, an event length, and/or other information associated with a claim 106. In various examples, the historical claim information 221 can include confirmation as to whether a claim payment provider 109 approved a given claim 106 and the associated amount that was paid by the claim payment provider 109.

At block 327, the accelerated transaction service 127 approves the application based at least in part on an analysis of the historical claim information 221 provided by the claim management service 264 and the information included in the application. For example, the accelerated transaction service 127 can analyze the historical claim information 221 to determine a risk associated with accelerating payments to the user while waiting for the claim 106 to be processed by the claim payment provider 109. In addition, the accelerated transaction service 127 can determine a risk associated with the user based at least in part on an analysis of the user information included in the application. In some examples, the accelerated transaction service 127 can confirm accuracy associated with the information provided in the application. In various examples, if the risk is below a given threshold, the accelerated transaction service 127 approves the application. In some examples, a trusted third-party entity can vouch for the user and/or the information included in the application. As such, the accelerated transaction service 127 can approve the application based at least in part on the trusted third-party approval.

At block 330, the accelerated transaction service 127 can determine a lending limit associated with the user. For example, the lending limit corresponds to an amount of funds the accelerated transaction service 127 will allow to be provided to the user while waiting for one or more claims 106 to be processed. In various examples, the lending limit can be determined based at least in part on a number of factors, including, a credit score, a payment history, a length of credit history, a net worth of the user, a working capital associated with the user, an average number of claims 106 pending at a given time, an average value associated with pending claims 106, an average turnaround time for the claim payment provider to process the claim 106, and/or other factors.

At block 333, the accelerated transaction service 127 notifies the client application 241 that the application has been approved. For example, the accelerated transaction service 127 can generate a notification and send the notification to the client device 212. The notification can include an email, an SMS message, a user interface 279, and/or other type of notification. In some examples, the notification can include the lending limit. In other examples, the lending limit is not communicated to the client application 241.

At block 336, the client application 241 completes the agreement to participate in the accelerated transaction program. In some examples, the notification can be rendered on a user interface 279 provided by the client application 241 and can include selectable components that when selected by the user indicates acceptance and completion of the agreement. In some examples, the client application 241 can render a user interface 279 associated with the accelerated transaction service 127 that includes a text entry box or other component that allows the user to submit a signature accepting the agreement, and thereby completing the agreement. Upon obtain the appropriate approval via user interactions by the user with a user interface 279, the client application 241 can complete the application.

At block 339, the client application 241 can provide account information to the accelerated transaction service 127. The account information can include payment instrument identifiers 253 that the accelerated transaction service 127 can use when initiating accelerated claim transactions 130.

At block 342, the accelerated transaction service 127 establishes an accelerated transaction user account 244 for the user. By establishing the accelerated transaction user account 244, the accelerated transaction service 127 completes the registration process to allow the user to be a registered participant in the accelerated transaction program.

At block 345, the client application 241 can set configuration data for the accelerated transaction account. For example, the user can configure options for activating and/or deactivating participation in the accelerated transaction program. In some examples, the client application 221 can define which types of claims 106 the user would like to be subject to accelerated payments, a time period to activate participation in the accelerated transaction program (e.g., thirty days, alternating months, etc.), and/or other options. Thereafter, this portion of the process proceeds to completion.

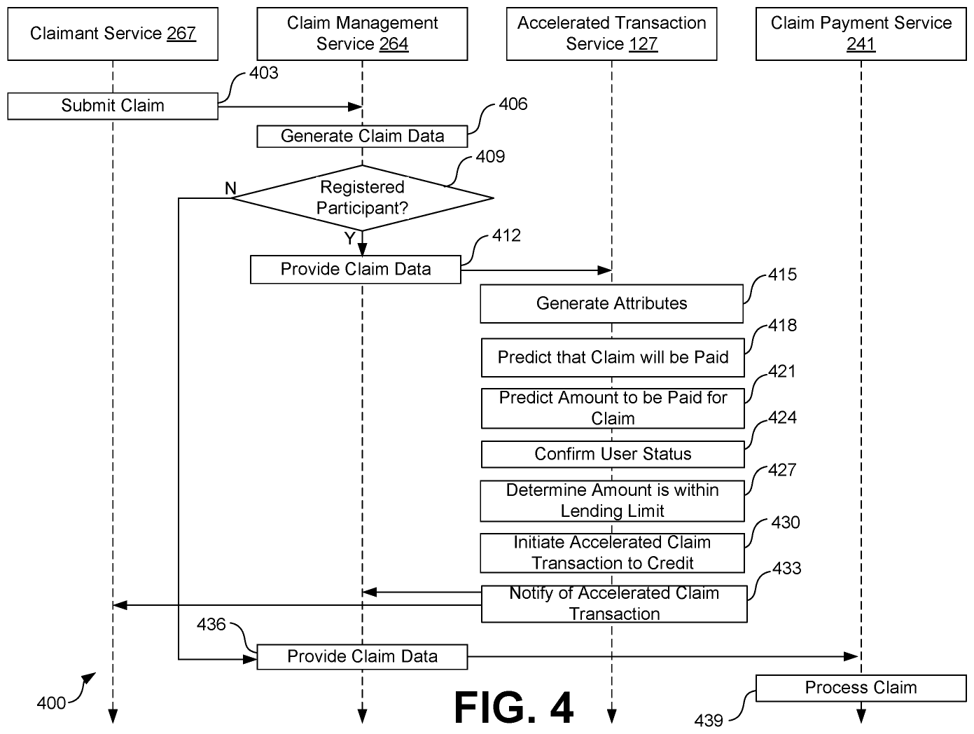

Next, FIG. 4 illustrates a sequence diagram 400 that provides one example of the interactions between the claimant service 267, the claim management service 264, the accelerated transaction service 127, and the claim payment service 241. The sequence diagram of FIG. 4 provides merely an example of the many different types of functional arrangements that can be employed by the claimant service 267, the claim management service 264, the accelerated transaction service 127, and the claim payment service 241. As an alternative, the sequence diagram of FIG. 4 can be viewed as depicting an example of elements of a method implemented within the network environment 200. FIG. 4 provides an example of how the accelerated transaction service 127 can initiate an accelerated claim transaction 130 (FIG. 1) in response to a claim 106 being submitted to the claim management service 264.

Beginning with block 403, the claimant service 267 submits a claim 106 to the claim management service 264. In various examples, the claim 106 includes a request for payment or reimbursement of funds that a user believes is owed to them based at least in part on an occurrence of an event (e.g., services performed, lost and/or damaged goods, etc.). The claim 106 can include information describing the event and providing details that can be used to determine whether to approve and/or deny the claim 106. In various examples, the information can include a claim event type, a user data (e.g., user name, user identifier, etc.), diagnosis data, service code data, CPP data 218, a seasonality, an event length, and/or other information associated with a claim 106. For example, the event can correspond to services provided to a patient by a medical provider 103 (FIG. 1) where the patient has an agreement with a claim payment provider 106 that allows the claim payment provider 106 to provide payment for the services to the medical provider 103 on behalf of the patient. In order to receive payment for the performed service, the medical provider 103 submits a claim 106 that includes details associated with the service performed. In some examples, the claim 103 can include a form (e.g., 837 form) that is an electronic file that contains patient claim information (e.g., patient identifier, diagnosis code, service code, claim payment provider information, length of stay, service type, etc.).

At block 406, the claim management service 264 generates claim data 115. In some examples, the claim data 115 can be generated by extracting the information included in the claim 106. For example, if the claim 106 corresponds to a form with various entry boxes for different types of information associated with the event, the claim management service 264 can extract the information needed from the form to generate the claim data 115. In some examples, the claim management provider 109 can generate claim data 115 by reformatting the information included in the claim 103 into a format that is accepted by the claim payment provider 109.

At block 409, the claim management service 264 determines whether the user submitting the claim 106 is a registered participant in the accelerated transaction program. When a user becomes a registered participant in the accelerated transaction program, the accelerated transaction service 127 can send a notification to the claim management service 264 identifying the user (e.g., user account identifier 253, etc.). Accordingly, the claim management service 264 can log or otherwise record the relationship between the user and the accelerated transaction services 127. For example, in determining whether the user submitting the claim 106 is a registered participant, the claim management service 264 can compare an identifier associated with the user with a log of registered participants to determine if there is a match between the user submitting the claim and the known registered participants. If the user is a registered participant, the claim management service 264 proceeds to block 412. Otherwise, the claim management service 264 proceeds to block 436.

At block 412, the claim management service 264 provides the claim data 115 associated with the claim 106 to the accelerated transaction service 127. In some examples, the claim management service 264 can verify that consent has been received allowing the claim management service 264 to provide the claim data 115 to the accelerated transaction service 127.

At block 415, the accelerated transaction service 127 generates attributes associated with the claim data 115, user data, claim payment provider data, historical data, and/or other type of data associated with the event of the claim 106. Using the example of FIG. 1 with respect to a medical provider 103 submitting a claim 103 based on services performed on a patient, the attributes can include claim payment provider identifier, a sum of historical payments for claims of the same patient, a number of no payment claims associated with the same patient, a service code, a diagnosis type, a number of claims associated with the patient, a type of claim payment provider, an average number of noncovered and/or denied amounts for the type of service provided, historical data associated with past payments of claims between the medical provider 103 and the claim payment provider 109 for the service performed, a length of stay or time for services to be performed, a number of diagnosis, and/or other information.

At block 418, the accelerated transaction service 127 predicts whether the claim payment provider will provide a payment 109 to satisfy the claim 106. For example, the accelerated transaction service 127 can execute a payment prediction model 227 and apply a first set of attributes from the determined attributes as inputs to the payment prediction model 227. The payment prediction model 227 can be trained to output a payment prediction score which can be used to predict whether the claim payment provider 109 will approve the claim 106 and provide a payment to the registered participant for the services and/or other events associated with the claim 106. For example, if the payment prediction score meets or exceeds a predefined threshold value, the accelerated transaction service 127 can predict that the claim 106 will be approved and a payment will be made by the claim payment provider 109.

At block 421, the accelerated transaction service 127 predicts an amount to be paid for the claim 106 by the claim payment provider 109. In various examples, the accelerated transaction service 127 apply a second set of attributes to a payment amount model 230 which is trained to provide an estimated amount for what is predicted to be provided to the registered participant by the claim payment provider 109 in view of the submitted claim 106. Accordingly, the output of the payment amount model 230 includes a value that corresponds to an estimated payment amount for the claim 106. In some examples, the first set of attributes are the same as the second set of attributes. In other examples, the first set of attributes can differ from the second set of attributes. As such, the attributes that are used to predict payment can differ from the attributes used to estimate a payment amount.

At block 424, the accelerated transaction service 127 confirms the user status with the accelerated transaction program. For example, the accelerated transaction service 127 can determine whether the registered participant is in good standing with the accelerated transaction program. For example, the accelerated transaction service 127 can review the user account data including the user history data 259 to determine whether the registered participant satisfies the terms set forth in an agreement between the registered participant and an entity associated with the accelerated transaction program.

At block 427, the accelerated transaction service 127 determines whether the predicted amount is within the lending limit assigned to the user. For example, the accelerated transaction service 127 can determine the current credit limit associated with the registered participant to determine whether the estimated amount is within the current credit limit or whether the estimated amount exceeds the current credit limit. In some examples, the current credit limit can be determined by calculating the difference between the assigned credit limit that can be included in the lending parameters 236 of the user account data with the advance balance 239 associated with the registered participant. For example, a registered participant may have a credit limit of $10,000 and may have already received credits of up to $9500 (e.g., account balance 239) for previously submitted claims that are still waiting to be approved and/or processed by the claim payment provider 109. The advance balance 239 can correspond to the amount of received credits that have already been provided to the registered participant. As such, if the estimated amount exceeds $500, for this example, the accelerated transaction service 127 can determine that only $500 or less of the total estimated amount will be credited to the transaction account 121 of the registered participant.

At block 430, the accelerated transaction service 127 initiates the accelerated claim transaction 130 to credit the transaction account 121 a value that is based at least in part on the estimated amount. In some examples, the credited amount corresponds to the estimated amount or available amount. In other examples, the credited amount corresponds to the estimated amount or available amount less a service fee for participation in the accelerated transaction program. In various examples, the account balance 239 can be updated to reflect the credited amount.

At block 433, the accelerated transaction service 127 generates and sends a notification of the accelerated claim transaction 130 to the claimant service 267, claim management service 264, and/or other applications to provide notice to the user and/or the claim management provider 112 that a credit has been applied to the transaction account 121 of the user. The notification can include an email, an SMS message, a user interface 279, and/or other type of notification.

At block 436, the claim management service 264 provides the claim data 115 to the claim payment service 241. According to various examples, a claim management provider 112 can function as an intermediary between a user and a claim payment provider 109 to facilitate in the financial management process associated with the event experienced by the user and receipt of payment associated with the event. In various examples, the claim management service 264 can identify a claim payment provider 109 associated with the claim 106 based at least in part on the claim data 115. Accordingly, the claim management service 264 can transmit the claim data 115 to the claim payment service 224 associated with the identified claim payment provider 109.

At block 439, the claim payment service 241 can process the claim 106 based at least in part on an analysis of the claim data 115. The claim payment service 224 can analyze the claim data 115 and determine whether to approve and/or deny the associated claim 106 based at least in part on agreement terms between the user and the claim payment provider 109. In some examples, manual review of the claim 106 is required prior to approval and/or denial of a claim. If approved, the claim payment provider 109 can initiate an approved claim transaction 118 with user to provide payment of the approved funds to the transaction account 121 associated with the user. The claim payment provider 109 can also generate and send a payment notification 124 to the claim management service 264 indicating that the approved claim transaction 118 associated with the submitted claim 106 has been processed and approved. Thereafter, this portion of the process proceeds to completion.

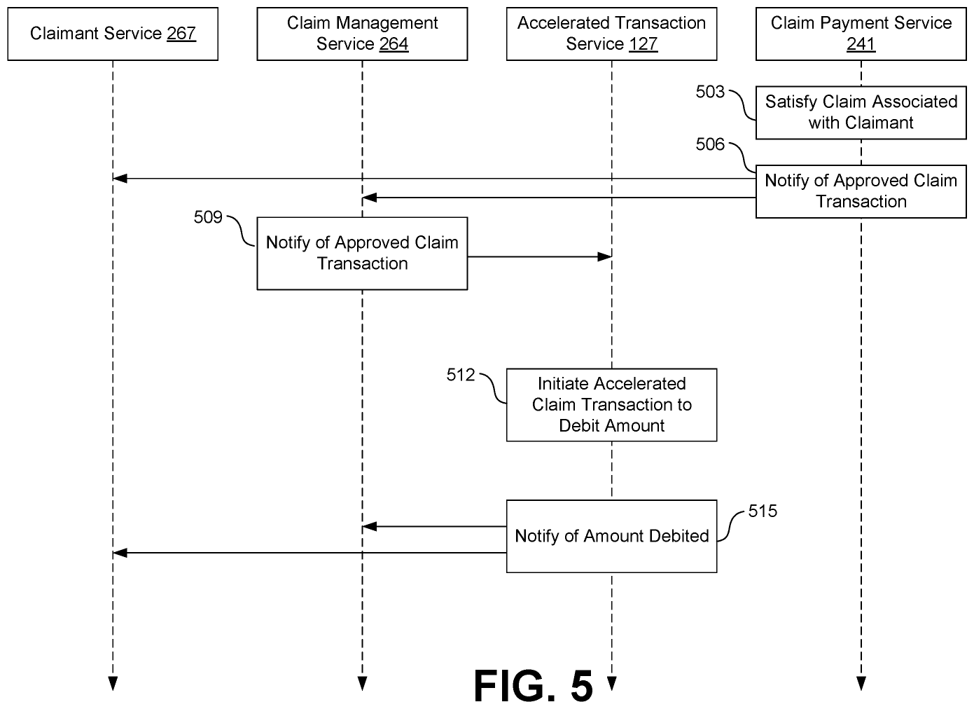

Turning now to FIG. 5, shown is a sequence diagram 500 that provides one example of the interactions between the claimant service 267, the claim management service 264, the accelerated transaction service 127, and the claim payment service 241. The sequence diagram of FIG. 5 provides merely an example of the many different types of functional arrangements that can be employed by the claimant service 267, the claim management service 264, the accelerated transaction service 127, and the claim payment service 241. As an alternative, the sequence diagram of FIG. 5 can be viewed as depicting an example of elements of a method implemented within the network environment 200. FIG. 5 provides an example of the accelerated transaction service 127 initiating an accelerated claim transaction 130 (FIG. 1) that debits a previously credited amount in response to determining that a claim 106 has been paid by a claim payment provider 109.

Beginning with block 503, the claim payment service 241 satisfies the claim 106 submitted by a user who is a registered participant in the accelerated transaction program. The claim payment service 224 can analyze the claim data 115 and determine whether to approve and/or deny the associated claim 106 based at least in part on agreement terms between the user and the claim payment provider 109. If approved, the claim payment provider 109 can initiate an approved claim transaction 118 with the user to provide payment of the approved funds to the transaction account 121 associated with the user.

At block 506, the claim payment service 241 notifies the claimant service 267, claim management service 264, and/or other application of the approved claim transaction 118. For example, the claim payment service 241 can generate and send a payment notification 124 to the claimant service 267, claim management service 264, and/or other application to provide notice to the user and/or the claim management provider 112 that the claim 106 has been satisfied and paid. The notification can include an email, an SMS message, a user interface 279, and/or other type of notification. In various examples, the payment notification 124 can include an amount that was paid to the user and/or other information related to the claim 106 and/or the approved claim transaction 118.

At block 509, the claim management service 264 notifies the accelerated transaction service 127 of the approved claim transaction 118. In various examples, the claim payment service 241 can forward the payment notification 124 received from the claim payment service 241 to the accelerated transaction service 127 to provide notice that the claim 106 has been satisfied and paid. In various examples, the payment notification 124 can include an amount that was paid to the user and/or other information related to the claim 106 and/or the approved claim transaction 118. In other examples, the claim management service 264 can generate and transmit another notification to the accelerated transaction service 127 indicating the approved claim transaction 118.

At block 512, the accelerated transaction service 127 initiates an accelerated claim transaction 130 to debit the amount of funds from the transaction account 121 that were originally credited based at least in part on a predicted payment amount. For example, if the accelerated transaction service 127 credited the transaction account 121 in the amount of $500 based at least in part on a predicted amount, the accelerated claim transaction 130 will correspond to a debit of $500 from the transaction account 121. In various examples, the account balance 239 can be updated to reflect the debited amount.

In some examples, the accelerated transaction service 127 can initiate the accelerated claim transaction 130b that debits the amount of funds from the transaction account 121 in response to receiving the payment notification 124 for a given claim and/or determining that a payment notification 124 for a given claim has failed to be received during an allotted time period. In other examples, the accelerated transaction service 127 can initiate the accelerated claim transaction 130b that debits an aggregated amount from the transaction account 121 in accordance to a given date (e.g., due date) or interval period (e.g., weekly, monthly, etc.). For example, an accelerated claim transaction 130b that debits funds from the transaction account 121 can be initiated in accordance to an interval period (e.g., monthly) and the amount debited can correspond to the aggregated amount of funds associated with claims where payment notifications 124 were received during the interval period plus any outstanding amounts that have not been satisfied by the third-party claim payment provider 109 after a predefined period of time and/or number of cycles.

At block 515, the accelerated transaction service 127 notifies the claimant service 267, claim management service 264, and/or other application of the accelerated claim transaction 130 to debit the funds from the transaction account 121 associated with the user. For example, the claim payment service 241 can generate and send a notification to the claimant service 267, claim management service 264, and/or other application to provide notice of the accelerated claim transaction 130. The notification can include an email, an SMS message, a user interface 279, and/or other type of notification. Thereafter, this portion of the process proceeds to completion.

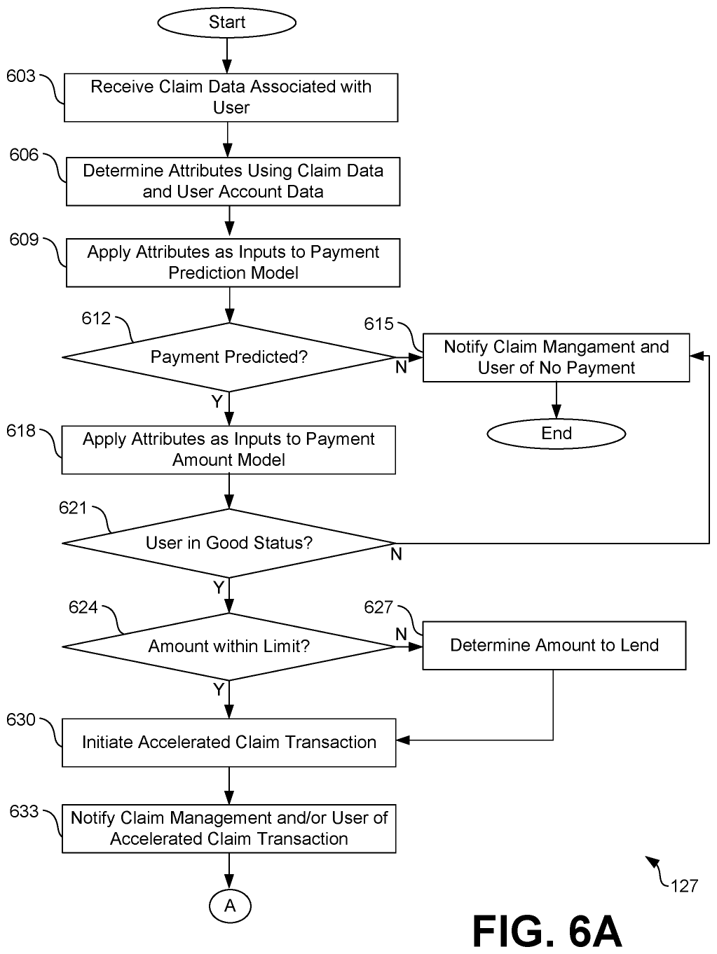

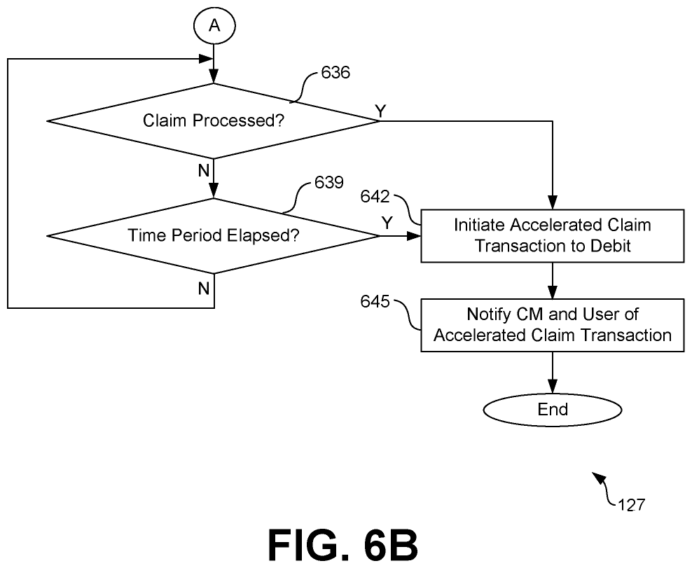

Referring next to FIGS. 6A and 6B, shown is a flowchart that provides one example of the operation of a portion of the accelerated transaction service 127. The flowchart of FIGS. 6A and 6B provides merely an example of the many different types of functional arrangements that can be employed to implement the operation of the depicted portion of the accelerated transaction service 127. As an alternative, the flowcharts of FIGS. 6A and 6B can be viewed as depicting an example of elements of a method implemented within the network environment 200.

Beginning with block 603, the accelerated transaction service 127 receives claim data 115 associated with a user who is a registered participant in an accelerated transaction program and has submitted a claim 106 requesting payment or reimbursement from a claim payment provider 109 due to an occurrence of an event (e.g., services performed, goods lost or damages, etc.). The claim data 115 can include information included in the claim 106 that defines the event and information needed to process the claim 106.

At block 606, the accelerated transaction service 127 determines attributes associated with the claim data 115, user data, claim payment provider data, historical data, and/or other type of data associated with the event of the claim 106. Using the example of FIG. 1 with respect to a medical provider 103 submitting a claim 103 based on services performed on a patient, the attributes can include claim payment provider identifier, a sum of historical payments for claims of the same patient, a number of no payment claims associated with the same patient, a service code, a diagnosis type, a number of claims associated with the patient, a type of claim payment provider, an average number of noncovered and/or denied amounts for the type of service provided, historical data associated with past payments of claims between the medical provider 103 and the claim payment provider 109 for the service performed, a length of stay or time for services to be performed, a number of diagnosis, and/or other information.

At block 609, the accelerated transaction service 127 can execute a payment prediction model 227 and apply the attributes as inputs to the payment prediction model 227. The payment prediction model 227 can be trained to output a payment prediction score which can be used to predict whether the claim payment provider 109 will approve the claim 106 and provide a payment to the registered participant for the services and/or other events associated with the claim 106.

At block 612, the accelerated transaction service 127 determines whether a payment is predicted. For example, if the payment prediction score that is outputted from the payment prediction model 227 meets or exceeds a predefined threshold value, the accelerated transaction service 127 can predict that the claim 106 will be approved and a payment will be made by the claim payment provider 109. Otherwise, the accelerated transaction service 127 will predict that no payment will be made.

If no payment is predicted, the accelerated transaction service 127 can proceed to block 615 and notify the claim management service 264 that no payment is predicted. For example, the accelerated transaction service 127 can generate and send a notification to the claimant service 267, claim management service 264, and/or other applications to provide notice that no payment will be made on behalf of the accelerated transaction program. The notification can include an email, an SMS message, a user interface 279, and/or other type of notification. Thereafter, this portion of the process proceeds to completion.

If payment is predicted, the accelerated transaction service 127 will proceed to block 618. At block 618, the accelerated transaction service 127 applies the attributes to a payment amount model 230 which is trained to provide an estimated amount for what is predicted to be provided to the registered participant by the claim payment provider 109 in view of the submitted claim 106. Accordingly, the output of the payment amount model 230 includes a value that corresponds to an estimated payment amount for the claim 106.

At block 621, the accelerated transaction service 127 determines whether the user is in good status or standing with the accelerated transaction program. For example, the accelerated transaction service 127 can review the user account data including the user history data 259 to determine whether the registered participant satisfies the terms set forth in an agreement between the registered participant and an entity associated with the accelerated transaction program. If the user is in good standing the accelerated transaction service 127 will proceed to block 624. Otherwise, the accelerated transaction service 127 will proceed to block 615.

At block 624, the accelerated transaction service 127 determines whether the predicted amount is within the lending limit assigned to the user. For example, the accelerated transaction service 127 can determine the current credit limit associated with the registered participant to determine whether the estimated amount is within the current credit limit or whether the estimated amount exceeds the current credit limit. In some examples, the current credit limit can be determined by calculating the difference between the assigned credit limit that can be included in the lending parameters 236 of the user account data with the advance balance 239 associated with the registered participant. If the estimated amount is within the lending limit, the accelerated transaction service 127 proceeds to block 630. Otherwise, the accelerated transaction service 127 proceeds to block 627.

At block 627, the accelerated transaction service 127 determines an amount to provide to the registered participant. For example, a registered participant may have a credit limit of $10,000 and may have already received credits of up to $9500 (e.g., account balance 239) for previously submitted claims that are still waiting to be approved and/or processed by the claim payment provider 109. The advance balance 239 can correspond to the amount of received credits that have already been provided to the registered participant. As such, if the estimated amount exceeds $500, for this example, the accelerated transaction service 127 can determine that only $500 or less of the total estimated amount will be credited to the transaction account 121 of the registered participant.

At block 630, the accelerated transaction service 127 initiates the accelerated claim transaction 130 to credit the transaction account 121 a value that is based at least in part on the estimated amount. In some examples, the credited amount corresponds to the estimated amount or available amount (e.g., amount determined in block 627). In other examples, the credited amount corresponds to the estimated amount or available amount less a service fee for participation in the accelerated transaction program. In various examples, the account balance 239 can be updated to reflect the credited amount.

At block 633, the accelerated transaction service 127 generates and sends a notification of the accelerated claim transaction 130 to the claimant service 267, claim management service 264, and/or other applications to provide notice to the user and/or the claim management provider 112 that a credit has been applied to the transaction account 121 of the user. The notification can include an email, an SMS message, a user interface 279, and/or other type of notification.

At block 636, the accelerated transaction service 127 determines whether the claim has been processed by the claim payment service 224. For example, the accelerated transaction service 127 can determine that the claim has been processed in response to receiving a payment notification 124 indicating that payment has been paid with respect to the claim 106. In some examples, if the claim 106 has been denied by the claim payment service 224, the accelerated transaction service 127 can be notified by the claim management provider 112 and/or other service that the claim has been processed and denied. As such, the accelerated transaction service 127 can determine that the claim has been processed and proceed to block 642. If the claim has not been processed, the accelerated transaction service 127 can proceed to block 639.

At block 639, the accelerated transaction service 127 can determine whether a defined time period has elapsed since the accelerated claim transaction 130 crediting the transaction account 121 of the user with respect to the claim 106. For example, an agreement between a lender entity associated with the accelerated transaction program and the registered participant may indicate a time period in which the lender entity will provide the funds to the registered participant. In this example, the time period may correspond to three months or some other time period that could correspond to an expected time period for the claim payment provider 109 to process the claim 106 for the user. If the time period has not elapsed, the accelerated transaction service 127 can proceed back to block 636. Otherwise, the accelerated transaction service 127 proceeds to block 642.

At block 642, the accelerated transaction service 127 initiates an accelerated claim transaction 130 to debit the amount of funds from the transaction account 121 that were originally credited based at least in part on a predicted payment amount. For example, if the accelerated transaction service 127 credited the transaction account 121 in the amount of $500 based at least in part on a predicted amount, the accelerated claim transaction 130 will correspond to a debit of $500 from the transaction account 121. In various examples, the account balance 239 can be updated to reflect the debited amount.

At block 645, the accelerated transaction service 127 notifies the claimant service 267, claim management service 264, and/or other application of the accelerated claim transaction 130 to debit the funds from the transaction account 121 associated with the user. For example, the claim payment service 241 can generate and send a notification to the claimant service 267, claim management service 264, and/or other application to provide notice of the accelerated claim transaction 130. The notification can include an email, an SMS message, a user interface 279, and/or other type of notification. Thereafter, this portion of the process proceeds to completion.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random access portion of the memory and run by the processor, source code that can be expressed in proper format such as object code that is capable of being loaded into a random access portion of the memory and executed by the processor, or source code that can be interpreted by another executable program to generate instructions in a random access portion of the memory to be executed by the processor. An executable program can be stored in any portion or component of the memory, including random access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random access memory (SRAM), dynamic random access memory (DRAM), or magnetic random access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts and sequence diagrams show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts and sequence diagrams show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts and sequence diagrams can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random access memory (RAM) including static random access memory (SRAM) and dynamic random access memory (DRAM), or magnetic random access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment 203, 206, 209.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a computing device comprising a processor and a memory; and
machine-readable instructions stored in the memory that, when executed by the processor, cause the computing device to at least:
receive claim data associated with a user registered to participate in an acceleration transaction program;
identify a plurality of attributes from the claim data and user account data associated with the user;
predict that a claim will be approved by a claim payment provider by applying a first set of the plurality of attributes to a payment prediction model;
estimate an amount for a claim payment by applying a second set of the plurality of attributes to an amount prediction model;
determine to accelerate a payment of the claim based at least in part on the estimated amount; and
initiate an accelerated claim transaction that credits a transaction account associated with the user with an accelerated transaction amount that is based at least in part on the estimated amount.

2. The system of claim 1, wherein the plurality of attributes comprise at least one of a user history, a payment history, a claim event type, diagnosis data, claim event data, an event length, user data, claim payment provider data, or a seasonality.

3. The system of claim 1, wherein an output of the payment prediction model comprises a probability score and, when executed, the machine-readable instructions further cause the computing device to at least compare the probability score with a threshold value, the claim predicted to be approved when the probability score fails to meet or exceed the threshold value.

4. The system of claim 1, wherein the accelerated claim transaction comprises a first accelerated claim transaction and, when executed, the machine-readable instructions further cause the computing device to at least:
determine that the claim payment provider has approved the claim; and
initiate a second accelerated claim transaction that debits the accelerated transaction amount from the transaction account.

5. The system of claim 1, wherein the accelerated claim transaction comprises a first accelerated claim transaction and, when executed, the machine-readable instructions further cause the computing device to at least:
determine that the claim has failed to be approved by the claim payment provider within a predefined period of time; and
initiate a second accelerated claim transaction that debits the accelerated transaction amount from the transaction account.

6. The system of claim 1, wherein, when executed, the machine-readable instructions further cause the computing device to at least:
generate a notification indicating the accelerated claim transaction has been completed in response to crediting the transaction account of the user; and
transmit the notification to a client device associated with the user.

7. The system of claim 1, wherein, when executed, the machine-readable instructions further cause the computing device to at least:
identify a credit limit associated with a registered participant account associated with the user; and
determine that the estimated amount exceeds the credit limit, the accelerated transaction amount that is credited to transaction account being based at least in part on the credit limit.

8. The system of claim 1, wherein the claim data associated with the user is received from a claim management computing device associated with a claim management entity, the claim management entity being an intermediary between the user and the claim payment provider.

9. A method, comprising:
generating a plurality of attributes based at least in part on an analysis of claim event data associated with a user registered to participate in an accelerated transaction program;
applying a first set of the plurality of attributes to a payment prediction model;
predicting that an approved claim transaction will be initiated by a claim payment provider based at least in part on a comparison of a payment prediction score that is output from the payment prediction model with a predefined threshold;
applying a second set of the plurality of attributes to a payment amount model, an output of the payment amount model comprising an estimated amount of the approved claim transaction; and
initiating a user with an accelerated transaction amount based at least in part on the estimated amount.

10. The method of claim 9, comprising:
receiving the claim event data from a claim management computing device associated with a claim management entity, the claim management entity being an intermediary between the user and the claim payment provider.

11. The method of claim 10, comprising:
receiving consent from a client device associated with the user; and
transmitting the consent to the claim management computing device, the consent allowing the claim management entity to provide the claim event data associated with the user.

12. The method of claim 9, wherein the plurality of attributes comprise at least one of a user history, a payment history, a claim event type, diagnosis data, claim event data, an event length, user data, claim payment provider data, or a seasonality.

13. The method of claim 9, wherein the accelerated claim transaction comprises a first accelerated claim transaction, and further comprising initiating a second accelerated claim transaction to debit the accelerated transaction amount from a transaction account associated with the user in response to determining that a predefined period of time has elapsed since crediting the transaction account.

14. The method of claim 9, wherein the accelerated claim transaction comprises a first accelerated claim transaction, and further comprising initiating a second accelerated claim transaction to debit the accelerated transaction amount from a transaction account associated with the user in response to determining that the claim payment provider has initiated the approved claim transaction.

15. A system, comprising:
a computing device comprising a processor and a memory; and
machine-readable instructions stored in the memory that, when executed by the processor, cause the computing device to at least:
receive a request to participate in an accelerated transaction program from a client device associated with a user, the request including a completed application and consent for an entity associated with the computing device to obtain claim event data associated with the user from a claim management entity;
notify the claim management entity of the consent received from the client device associated with the user;
obtain historical claim event data associated with the user from the claim management entity;
approve the completed application based at least in part on analysis of the historical claim event data; and
generate a notification indicating approval of the completed application for the user; and
transmit the notification to the client device and a claim management entity computing device.

16. The system of claim 15, wherein, when executed, the machine-readable instructions further cause the computing device to at least:
obtain pending claim event data associated with a claim submitted by the user;
predict that the claim will be approved by a claim payment provider based at least in part on an output of a payment prediction model, the pending claim event data corresponding to one or more attributes inputted into the payment prediction model;
predict a transaction amount the claim payment provider will provide the user based at least in part on a payment amount model; and
initiate an accelerated claim transaction to credit a transaction account with an accelerated transaction amount that is based at least in part on the predicted transaction amount.

17. The system of claim 16, wherein, when executed, the machine-readable instructions further cause the computing device to at least:
calculate a difference between the predicted transaction amount and a participant fee of the accelerated transaction program, the accelerated transaction amount corresponding to the difference.

18. The system of claim 16, wherein the accelerated claim transaction comprises a first accelerated claim transaction and, when executed, the machine-readable instructions further cause the computing device to at least:
confirm that the claim payment provider has approved the claim; and
initiate a second accelerated claim transaction to deduct the accelerated transaction amount from the transaction account.

19. The system of claim 15, wherein, when executed, the machine-readable instructions further cause the computing device to at least:
establish a lending service account for the user in response to approving the completed application and receiving account information associated with the user.

20. The system of claim 19, wherein, when executed, the machine-readable instructions further cause the computing device to at least:
generate one or more lending rules associated with the lending service account, the one or more lending rules comprising at least a lending amount limit.
